(19) United States
(12) Patent Application Publication
(10) Pub. No.: US 2015/0082298 A1
(43) Pub. Date: Mar. 19, 2015

(54) PACKAGING AND DEPLOYING HYBRID APPLICATIONS

(71) Applicants: Qiu Shi WANG, Singapore (SG); Lin CAO, Singapore (SG)

(72) Inventors: Qiu Shi WANG, Singapore (SG); Lin CAO, Singapore (SG)

(21) Appl. No.: 14/032,184

(22) Filed: Sep. 19, 2013

(51) Int. Cl. G06F 9/445

(52) U.S. Cl. CPC G06F 8/60
USPC 717/174

(57) ABSTRACT

Described herein is a technology to facilitate packaging and deployment of a hybrid application. In one implementation, one or more initial dependencies are identified from a configuration file associated with a hybrid application. Any issues associated with the initial dependencies may be resolved to generate one or more final dependencies. A package may be generated based on the one or more final dependencies and the hybrid application code. The package may then be deployed to a target device or device simulator.

### TECHNICAL FIELD

The present disclosure relates generally to a framework for packaging and deploying hybrid applications.

### BACKGROUND

Applications (or Apps) are developed for a wide variety of purposes. There are different types of Apps, such as native Apps, Web Apps and hybrid Apps. Native Apps are downloaded, installed and run on devices. A native App is written for a specific kind of platform and installed on a computing device. Native Apps take advantage of the various functions available on a device. On the other hand, Web Apps are generalized for multiple platforms and not installed locally on the device, but reside on a server. A device accesses a Web App through its browser. By being browser-based, any device with a browser can access Web Apps. In other words, Web Apps are not platform or device type-specific. However, Web Apps cannot cross the boundaries of web browsers, thus restricting access to some system-specific resources.

Hybrid Apps combine elements of both native and Web Apps. Hybrid Apps are based on Web technologies but use wrappers of native code. Such wrappers can provide various enhancements that are normally restricted to native Apps, such as a user interface (UI) with the look of a native App, better performance than pure Web Apps or access to device features such as camera or Global Positioning System (GPS). Hybrid Apps are integrated with a device's file system and Web-based services, and can function whether or not the device is connected to the server.

To provide such features, hybrid Apps have very complex dependencies. “Dependencies” arise when an App is coupled to one or more resources, such as a library, Javascript framework, style sheet, icon, images, other applications, etc. Packaging resources with such complex dependencies into an App (or software package) often involves a complicated and time-consuming process. For example, the developer needs to manually discover dependencies, manually resolve conflicts between dependencies, manually reduce package size, etc. An insufficiently compact App undesirably results in longer download and installation times, while software bugs may negatively impact functionality of the App.

From the foregoing discussion, it is desirable to provide effective and efficient framework for packaging hybrid Apps.

### SUMMARY

A technology to facilitate packaging and deployment of a hybrid application is described herein. In accordance with one aspect of the technology, one or more initial dependencies are identified from a configuration file associated with a hybrid application. Any issues associated with the initial dependencies may be resolved to generate one or more final dependencies. A package may be generated based on the one or more final dependencies and the hybrid application code. The package may then be deployed to a target device or device simulator.

In accordance with another aspect, code of a hybrid application and a configuration file containing properties of the hybrid application is received in response to a single user selection event initiated via a user interface. One or more initial dependencies may be identified from the configuration file. Any issues associated with the one or more initial dependencies may be resolved to generate one or more final dependencies. Further, the code of the hybrid application may be minified to generate minified code. A package may then be generated based on the one or more final dependencies and the minified code. The package may further be compressed and deployed to a target device or device simulator.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1a shows an exemplary environment;

FIG. 1b shows an exemplary App builder;

FIG. 1c shows an exemplary target device simulator;

FIG. 2 shows an exemplary process for packaging and deploying an App;

FIG. 3 shows an exemplary configuration file editor;

FIG. 4 shows an exemplary process for conflict resolution of dependencies; and

FIG. 5 shows an exemplary process for packaging an App for deployment.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

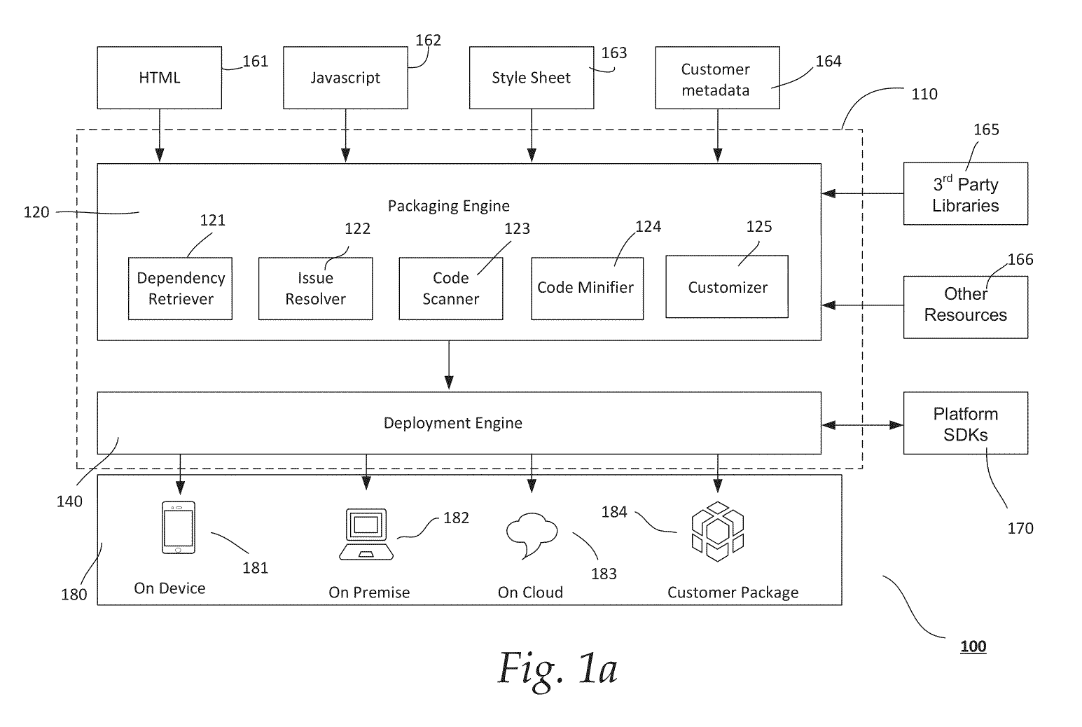

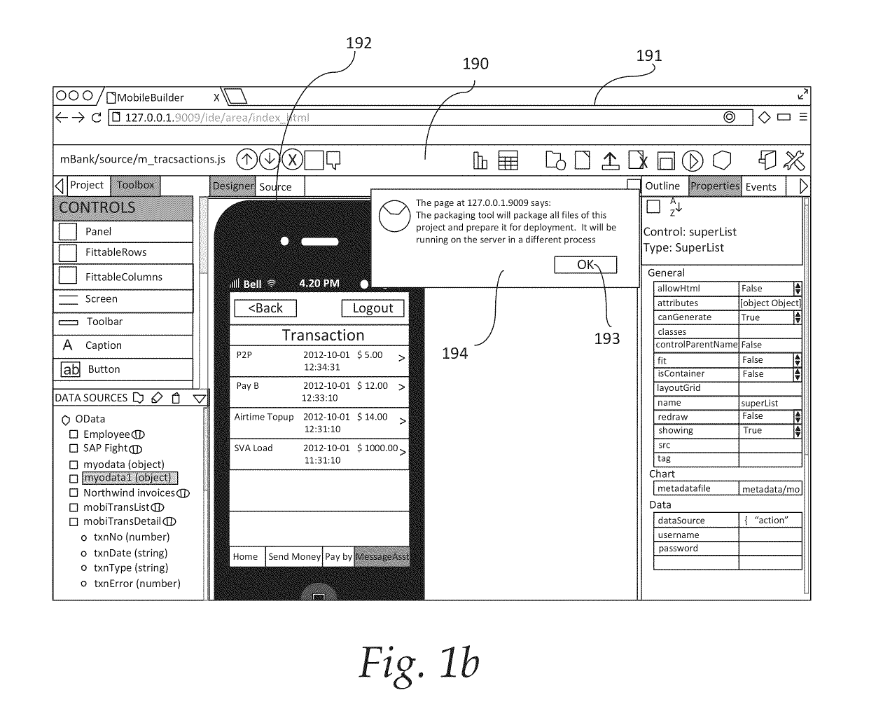

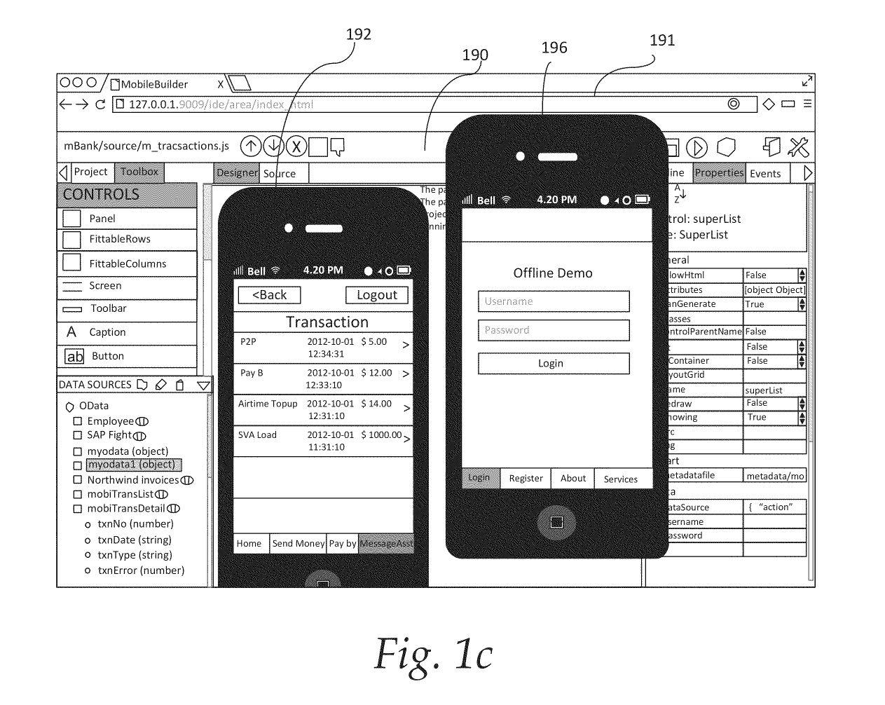

FIG. 1a shows a block diagram of an exemplary environment or architecture 100. Environment 100 may have a client/server architecture. For example, the environment may be a distributed client/server architecture. A client/server architecture may have one or more clients and one or more servers communicatively coupled via a communication network. The communication network, for example, may be a local area network (LAN) which interconnects different devices, such as the clients and the server. Other types or configurations of networks may also be useful. For example, the network may be interconnected to other networks through wide area network (WAN) or internet. The devices may be coupled via the network by wireless and/or wired connections. Clients may access the server or servers for storage or retrieval of information. Furthermore, a server may facilitate communication between clients.

A server, in one embodiment, may be a computer which includes a memory and a processor. The memory of a server may include any memory or database module. The memory may be volatile or non-volatile types of non-transitory computer-readable media, such as magnetic media, optical media, random access memory (RAM), read-only memory (ROM), removable media, or any other suitable local or remote memory component. The server is configured to transmit, receive, process and store information or data associated with the environment. Various types of computers may be employed. For example, the computer may be a mainframe, a workstation, as well as other types of processing devices. The server may be adapted to execute any operating system. For example, the operating system of the server may be z/OS, Linux-Intel, Linux/390, UNIX, or Windows Server. Other types of operating systems may also be used. The server may also include or be communicatively coupled with a web server and/or a Simple Mail Transfer Protocol (SMTP) server.

A client may be a local or remote computing device with, for example, a local memory and a processor. The memory may include fixed and/or removable non-transitory computer-readable media, such as a magnetic computer disk, CD-ROM, or other suitable media. Various types of processing devices may serve as a client. For example, the client may be a PC, a tablet PC, a workstation, a network computer, a kiosk or a mobile computing device, such as a laptop, a tablet or a smart phone. Other types of processing devices may also be used. The client can receive, transmit, process and store any appropriate data associated with the architecture.

Client/server (C/S) applications may be provided in the environment. Generally, C/S applications include front-end and back-end portions. The front-end portions are stored locally on the client devices while the back-end portions are implemented on the server. Various types of C/S applications may be provided in the environment. In some implementations, an App builder C/S application is implemented on the client device for designing Apps and invoking the App packager 110 to package and deploy the designed Apps.

FIG. 1b shows an exemplary App builder 190. The user may access the App builder 190 via a Web browser 191 on a client device. App builder 190 may be used to design, for example, a hybrid App 192. As discussed previously, a hybrid App 192 includes elements of both native and Web Apps. After the hybrid App 192 is designed, App builder 190 may invoke the App packager 110 to package and deploy the hybrid App 192 to a runtime execution environment.

In some implementations, App builder 190 invokes App packager 110 in response to a single user selection event initiated via a user interface, such as a mouse click, keyboard command, touch, gesture, voice command, etc. For instance, App builder 190 may present a user interface (UI) element (e.g., OK button) 193 in a text box 194 to inform the user that the App packager is proceeding to package all the files of the project as a container package (or installer), and deploy the container package to a target device (e.g., mobile device) or device simulator. In response to a single user selection event associated with the UI element 193, App builder 190 may invoke the packaging engine 120 and deployment engine 140, as will be described in more detail herein. After deployment, the hybrid App 192 may be executed on the target device or device simulator. FIG. 1c shows an exemplary device simulator 196 that is running the hybrid App 192 after deployment.

Referring back to FIG. 1a, App packager 110 may include App packaging engine 120 and App deployment engine 140. App packager 110 is a software tool for efficiently and effectively packaging and deploying Apps, particularly hybrid Apps. As discussed previously, hybrid Apps combine features of both Web and native Apps. App packager 110, for example, may be integrated into the App builder 190. App packager 110 may also be installed as a stand-alone tool on a server and be communicatively coupled to the App builder 190. Other configurations of App packager 110 may also be useful. For example, the packaging engine 120 and deployment engine 140 may be stand-alone tools.

Packaging engine 120 includes various modules or functions for packaging the App. In some implementations, packaging engine 120 includes a dependency retriever 121, an issue resolver 122, a code scanner 123, a code minifier 124 and a customizer 125. Providing more or fewer modules or other configurations of modules for the packaging engine 120 may also be useful.

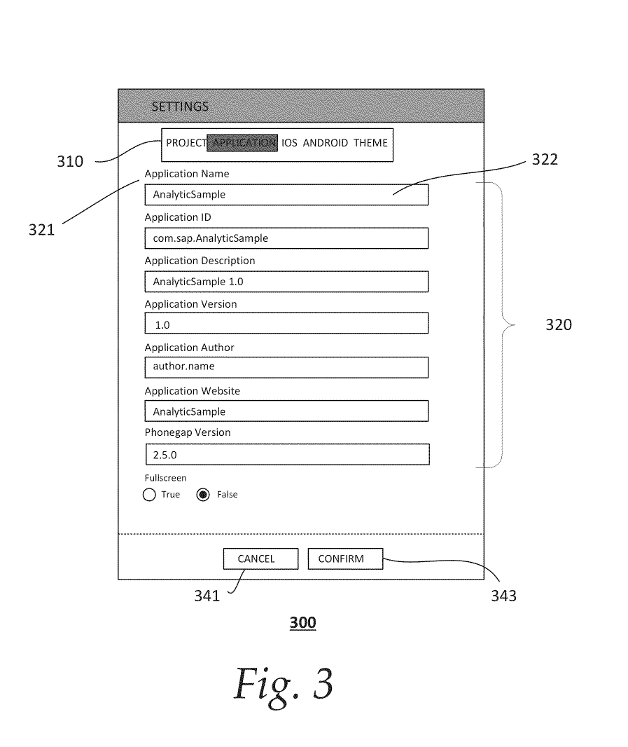

Dependency retriever 121 may serve to retrieve an initial list of dependencies used by the App to be packaged, which may be referred to herein as the project App. In some implementations, the dependency retriever 121 scans and parses a project configuration file of the project App to extract properties and dependencies of the project App. Such properties and dependencies may be explicitly defined by the developer using, for example, a visual editor, as will be described in more detail with reference to FIG. 3.

App properties contained in the project configuration file may include, for example, application name, runtime library type, target deployment environment (e.g., target device type, device simulator, target platform type, etc.), style sheet file used, application icon, and other resources. The target device type may be, for example, a mobile device (e.g., smartphone, laptop, etc.). The target platform type, for example, may be Mac OS X, iOS, Android, Unix, Linux, Blackberry, Windows, and so forth. Multiple target device types, device simulators and/or platform types may be specified in the project configuration file.

The initial list of dependencies includes dependencies between the App and one or more resources. Exemplary resources include, but are not limited to, HyperText Markup Language (HTML) code 161, Javascript framework 162, style sheets 163 (e.g., cascading style sheets or CSS), customer metadata 164, third party libraries 165 and other resources 166.

Issue resolver 122 may analyze the retrieved dependencies to determine and resolve any potential issues or errors that may arise when the App is actually deployed and executed during run-time. These problems may be due to, for example, many dependencies, long chains of dependencies, circular dependencies and/or conflicting dependencies. To resolve conflicts in the dependencies, for example, the issue resolver may remove any redundant library from the list of dependencies or add a new library. Other resolution solutions may be implemented, depending on the type of issue. After resolving any issues with the dependencies, the issue resolver 122 may generate a final runtime dependencies list. The final runtime dependencies list contains a set of dependencies that do not give rise to any issues or errors during runtime.

Code scanner 123 may serve to parse and analyze the code of the App to identify any opportunities to minify the code. For example, in the case of an App containing JavaScript code, code scanner 123 may identify whitespaces, line breaks, comments and/or unnecessary statements that can be removed, long variable names, function names and/or statements that can be optimized to reduce the size, and so forth. It should be appreciated that other types of code may also be analyzed and minified.

Code minifier 124 may then reduce the size of the code based on the identified minification opportunities. In some implementations, code minifier 124 removes any whitespace, line break, comment and/or unnecessary statement that have been identified by code scanner 123. Code minifier 124 may further optimize long variable names, function names and/or statements into shorter or more optimal forms. The minified code may be in a non human-readable form that is compact in size. The minified code may be combined with the resources specified in the final dependencies list into a single package. The package may then be compressed to obtain an even smaller file size to be deployed to the target device or device simulator for installation.

Packaging engine 120 may further include a customizer 125. Customizer 125 enables the user to configure the packaging engine 120 according to desired preferences. For example, the user may wish to specify a particular language, locale, custom user interface, and so forth. The user may also specify the minification level of the code minifier 124. The minification level may be, for instance, a simple level (e.g., remove only blank spaces) or an advanced level (e.g., rename long variable and function names to shorter names). Other types of customization may also be performed.

Deployment engine 140 may deploy the App package to the target device or device simulator using one or more platform Software Development Kit (SDKs) 170. A platform SDK provides the tools required for generating an application script to deploy the App package to a specific platform (e.g., Mac OS X, iOS, Android, Unix, Linux, Blackberry, Windows, etc.). Such tools may include, for instance, header files, libraries, samples, documentation, etc.

In some implementations, deployment engine 140 deploys the App package to multiple target devices or device simulators (i.e. one-to-many deployment) 180. The target devices 180 may include, but are not limited to, a mobile device 181, an on-premise computer 182, cloud computing system 183 and/or a customer package site location 184. Deploying to other types of target devices may also be useful. The target devices may also be simulated by using a device simulation (or emulation) software (e.g., iPhone simulator).

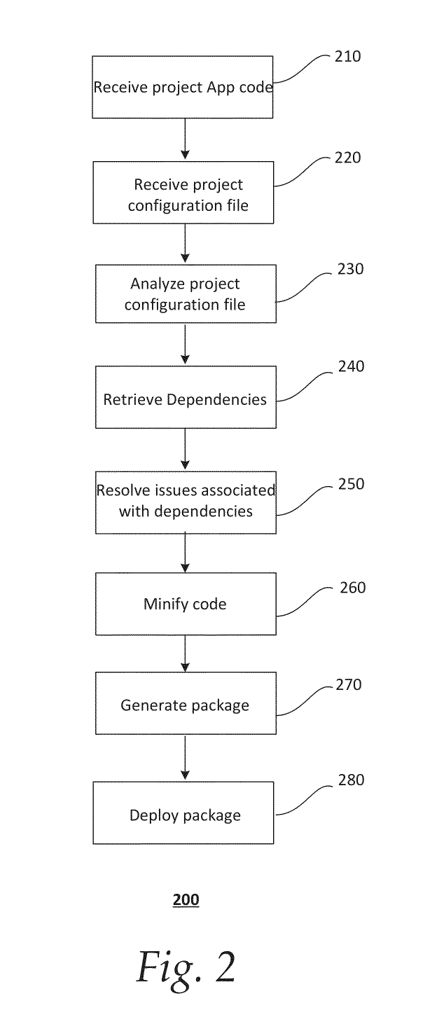

FIG. 2 shows an exemplary process 200 for packaging and deploying an App. The process 200 may be performed automatically or semi-automatically by the components previously described with reference to FIGS. 1a-1c. It should be noted that in the following discussion, reference will be made, using like numerals, to the components described in FIGS. 1a-1c.

At 210, the packager 110 receives code of a project App. In some implementations, the project App is developed by using an App builder 190, as previously described with reference to FIG. 1b. In response to a single user-selection event (e.g., mouse click, touch, gesture, voice command, keyboard command, etc.) initiated via a user interface, the project App may be communicated to the packager 110 for packaging and deployment.

At 220, the packager 110 further receives a project configuration file. In some implementations, the App builder 190 is provided with a configuration file generator to assist a user in defining the project configuration file while designing the project App. The configuration file generator may be, for instance, a visual editor with a graphical user interface. Other techniques for generating the project configuration file may also be useful. The project configuration file may be generated based on the project App. The project configuration file may be updated or regenerated after the packager 110 is invoked.

FIG. 3 shows an exemplary visual editor 300 for generating a project configuration file. The visual editor 300 may be presented by, for example, the App builder 190. The visual editor 300 includes a page selector 310. The page selector 310 includes titles of the different pages which can be selected for defining settings of the App. The titles include, for example, project, application, iOS, Android, and theme pages. Providing other types of pages may also be useful.

In some implementations, the project page may be provided to enable the user to configure general properties for the project. The application page may be provided to enable the user to configure properties for the App, such as the App name, unique identifier (id), description, version, author, author's website, PhoneGap version, full screen option, etc.

The iOS and Android pages may be provided for the user to configure project properties for the specific target platforms iOS and Android respectively. It should be noted that other pages for other types of platform may also be provided. Exemplary project properties configurable for the iOS platform may include, but are not limited to, webviewbounce, prerendered-icon, stay-in-webview, ios-statusbarstyle, detect-data-types, exit-on-suspend, show-splash-screen-spinner, auto-hide-splash-screen, icons for ldpi, mdpi, hdpi and xhdpi, and so forth. Exemplary project properties configurable for the Android platform may include, but are not limited to, android-minSdkVersion, android-installLocation, icons for ldpi, mdpi, hdpi and xhdpi, and so forth.

The Theme page may be provided to enable the user to configure Cascading Style Sheets (CSS) for the App. Exemplary properties for the CSS are as follows:

[

{“name”:“MVI”, “fullname”:“sap_mvi”,

“root”:“”},

{“name”:“BlueCrystal”, “fullname”:“sap_bluecrystal”,

“root”:“”},

{“name”:“Custom”,“fullname”:“sap_custom”,

“root”:“css/themes”}
]

The appropriate page can be selected by clicking on the desired heading in the page selector. As shown, the Application page is selected. Settings 320 in the Application page relates to the App. A setting includes a setting description 321 and an editable box 322. In some implementations, the Application settings include application name, application ID, application description, application version, application author, application website, and phonegap version. Providing other types of application settings may also be useful. A user may enter the appropriate information or values in the editable box 322 associated with the respective setting. The page also includes command tabs. As shown, the page includes first and second command tabs 341 and 343. The first command tab 341 is a cancel command tab and the second command tab is a confirm command tab 343.

Based on the information entered via, for example, the visual editor 300, a project configuration file may be generated. The project configuration file specifies properties of the project App, including but are not limited to, runtime library type, application name, device type for deployment, style sheets, file used, application icons, other resources, etc. Other types of properties may also be included in the project configuration file. An exemplary project configuration file is provided below:

{

“type”: “ui5”,
“AppName”: “AnalyticSample”,
“ProjectType”: “Generic Application”,
“DeviceType”: “Phone”,
“AppProperties”: {

“theme”: {

“name”: “MVI”,
“fullname”: “sap_mvi”,
“root”: “”

},
“cssfiles”: “css/CustomStyles.css”

},
“Themes”: [

{

“name”: “MVI”,
“fullname”: “sap_mvi”,
“root”: “”

},
{

“name”: “BlueCrystal”,
“fullname”: “sap_bluecrystal”,
“root”: “”

}

],
“DeviceOrientation”: {

“Orientations”: [

“Portrait”

],
“DefaultOrientation”: “Portrait”

},
“kapsel”: {

“ID”: “com.sap.AnalyticSample”,
“Version”: “1.0”,
“AppName”: “AnalyticSample”,
“Description”: “AnalyticSample 1.0”,
“Website”: “AnalyticSample”,
“Author”: “author.name”,
“preference”: {

“cordova_version”: “2.5.0”,
“fullscreen”: “False”,
“ios_statusbarstyle”: “default”,
“webviewbounce”: “False”,
“prerendered_icon”: “False”,
“stay_in_webview”: “False”,
“detect_data_types”: “False”,
“exit_on_suspend”: “False”,
“show_splash_screen_spinner”: “False”,
“auto_hide_splash_screen”: “False”,
“android_minSdkVersion”: “7”,
“android_installLocation”: “auto”

},
“icon”: {

“src”: “res/icon/icon_512.png”,
“ios”: {

“icon57”: “res/icon/icon_ios_57.png”,
“icon72”: “res/icon/icon_ios_72.png”,
“icon114”: “res/icon/icon_ios_114.png”,
“icon144”: “res/icon/icon_ios_144.png”

```
  },
  “android”: {
```

“ldpi”: “res/icon/icon_android_36.png”,
“mdpi”: “res/icon/icon_android_48.png”,
“hdpi”: “res/icon/icon_android_72.png”,
“xhdpi”: “res/icon/icon_android_96.png”

}

},
“access”: {

“origin”: “*”,
“subdomains”: “false”,
“browser only”: “false”

}

}

}

Returning back to FIG. 2, at 230, the dependency retriever 121 parses and analyzes the project configuration file to generate an initial list of dependencies between the resources used by the App at 240. The initial dependencies list may then be stored in, for example, an application index header. Storing the initial dependencies in other forms may also be useful.

An exemplary initial list of dependencies is as follows:

<script src=‘../../../runtime/common/sjcl.js’></script>
<script src=‘../../../runtime/common/common.js’></script>
<script src=‘../../../runtime/superlist/sap.superlist.js’></script>
<script src=‘../../../runtime/makit/scripts/sap.makit-3.0.min.js’></script>
<script src=‘../../../runtime/common/Data.js’></script>
<script src=‘../../../runtime/common/datajs-1.1.0.min.js’></script>
<script src=‘datasources.js’></script>
<script id=‘sap-ui-bootstrap’ type=‘text/javascript’

src=‘../../../runtime/ui5/resources/sap-ui-core.js’

data-sap-ui-preload=‘’

data-sap-ui-theme=‘sap_mvi’
data-sap-ui-libs=‘sap.m’></script>

<link type=“text/css” rel=“stylesheet” href=“css/ControlStyles.css”>
<link type=“text/css” rel=“stylesheet” href=“css/CustomStyles.css”>

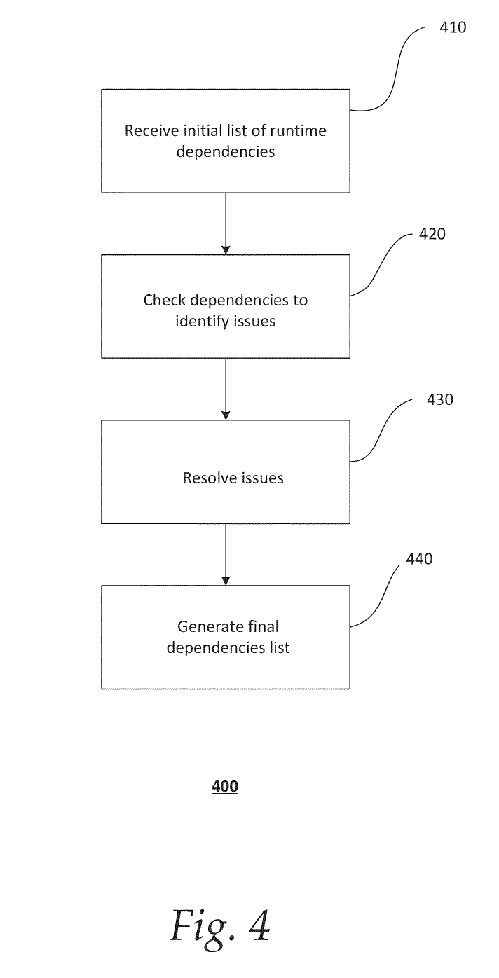

At 250, issue resolver 122 analyzes the initial list of dependencies and resolves any issues associated with it to generate a final list of runtime dependencies. Such issues may include, for example, many dependencies, long chains of dependencies, circular dependencies and/or conflicting dependencies. An exemplary method of resolving issues associated with the dependencies will be described in more detail later with reference to FIG. 4.

At 260, code scanner 123 scans the App code to identify opportunities for minification. Code minifier 124 then minifies the code based on such identified opportunities. For example, code minifier 124 may remove any whitespace, line break, comment and/or unnecessary statement that have been identified by code scanner 123. Code minifier 124 may further optimize any long variable names, function names and/or statements into shorter or more optimal forms.

At 270, the code minifier 124 packages the minified code for deployment. For example, the minified code may be combined with other resources into a single package. The package may further be compressed using a compression algorithm to further reduce its size and subsequent download time. Exemplary compression algorithms include lossless compression algorithms, such as gzip, pkzip, and so forth. A platform SDK 170 may also be used to generate the compressed package for installation at the target platform.

At 280, the deployment engine 140 deploys the package. The packaged App may be deployed to a target device (or device simulator), such as a mobile device, on-premise computer, cloud storage, or a customer package site location. Upon deployment, the package may be automatically executed on the target device or device simulator.

FIG. 4 shows an exemplary process 400 for issue resolution of runtime dependencies. The process 400 may be performed automatically or semi-automatically by the components previously described with reference to FIGS. 1a-1c. It should be noted that in the following discussion, reference will be made, using like numerals, to the components described in FIGS. 1a-1c.

At 410, the issue resolver 122 receives an initial list of runtime dependencies between resources from, for example, dependency retriever 121. An exemplary set of resources (e.g., runtime libraries) is shown in Table 1 below:

TABLE 1

| | Resources |
|---|---|
| 1 | MAKit v3.0 |
| 2 | MAKit v2.3 |
| 3 | Superlist 1.0 |
| 4 | SAP UI5 Mobile |
| 5 | SAP UI5 Desktop |
| 6 | 3^{rd} party libraries |

At 420, issue resolver 122 checks the initial list of dependencies to identify any issues. Issue resolver 122 may check the list to identify any conflict in target platforms, versions of resources, control types, etc. For instance, in the list of resources shown in Table 1, a conflict between the versions of the runtime library MAKit may be identified. In addition, another conflict between the versions of toolkit SAP UI5 may further be identified. Issue resolver 122 may further check the list to determine if it contains the latest and/or most reliable version of the resources.

At 430, issue resolver 122 resolves the identified issues. For example, libraries that are unrelated to the target deployment environment may be removed from the dependency list. For instance, if the user specifies the target device type to be a mobile device, libraries for desktop and other non-mobile devices may be removed.

Further, if there exist later reliable versions of resources than those provided by the dependency list, the resources are automatically upgraded, and the older versions are removed. Even further, component libraries may be merged. For instance, with respect to the conflict in versions of MAKit 3.0 and MAKit 2.0 as identified from Table 1, MAKit 2.0 may be removed since it is the relatively older version. If the user is using any obsolete functions from MAKit 2.0 in designing the App, such functions may be automatically replaced with new functions from MAKit 3.0.

At 440, a final runtime dependencies list is generated. The final dependencies list references resources that are free of issues. For example, the final dependencies list may reference the latest reliable versions of runtime libraries which are required. The final dependencies list is used to package the required resources into an App package for deployment.

An exemplary final dependencies list is as follows:

<script src=‘./lib/common/common.js’></script>
<script src=‘./lib/makit/scripts/sap.makit-3.0.min.js’></script>
<script src=‘./lib/common/datajs-1.1.0.min.js’></script>
<scriptsrc=‘datasources.js’></script>
<script type=“text/javascript” src=“cordova.js”></script>

<script id=‘sap-ui-bootstrap’ type=‘text/javascript’

src=‘./lib/ui5/resources/sap-ui-core.js’

data-sap-ui-preload=‘’

data-sap-ui-theme=‘sap_bluecrystal’
data-sap-ui-libs=‘sap.m’></script>

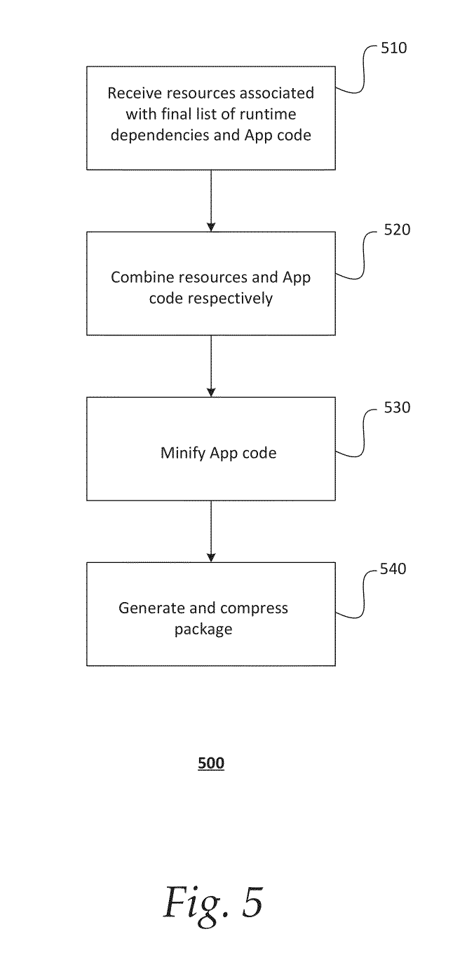

FIG. 5 shows an exemplary process 500 of producing an App package for deployment. The process 500 may be performed automatically or semi-automatically by the components previously described with reference to FIGS. 1a-1c. It should be noted that in the following discussion, reference will be made, using like numerals, to the components described in FIGS. 1a-1c.

At 510, resources associated with the final list of runtime dependencies and App code are retrieved. Exemplary resources include, for instance, runtime Javascript libraries, style sheets, images, and so forth. Exemplary App code includes, for example, Javascript files.

At 520, the resources and App code are combined respectively. For example, multiple runtime libraries, style sheets and other resources are combined into a combined resource package, while multiple Javascript files may be combined into a single Javascript file.

At 530, the App code is minified. As discussed previously, the App code may be minified by, for instance, removing any whitespace, line break, comment and/or unnecessary statement, and/or optimizing long variable names, function names and/or statements into shorter or more optimal forms.

At 540, the minified App code and combined resource package are combined to generate an App package. The App package may be further compressed by a compression algorithm to reduce its size. The compressed App package may then be deployed.

Based on the target platform configuration and the support of the platform SDK, an application script may further be generated to deploy the package to a specific target platform. An exemplary embodiment of an application script for an Android platform is shown below:

rem create Android project
cmd /c cordova create LeaveRequest com.sap.LeaveRequest

LeaveRequest

cd LeaveRequest
xcopy ..\www\* .\www /s /f /y
cmd /c cordova platform add android
copy ..\www\config.xml .\platforms\android\res\xml\ /y
copy..\www\res\icon\icon_512.png.\platforms\android\res\drawable\icon

.png /y

copy..\www\res\icon\icon_android_36.png.\platforms\android\res\drawa

ble-ldpi\icon.png /y

copy..\www\res\icon\icon_android_48.png.\platforms\android\res\drawa

ble-mdpi\icon.png /y

copy..\www\res\icon\icon_android_72.png.\platforms\android\res\drawa

ble-hdpi\icon.png /y

copy..\www\res\icon\icon_android_96.png.\platforms\android\res\drawa

ble-xhdpi\icon.png /y

rem Adding plug-ins
set kapselsdk-path=c:\kapselsdk
kapsel add %kapselsdk-path%\corelibs
kapsel add %kapselsdk-path%\logon
kapsel add %kapselsdk-path%\appupdate

In summary, packager 110 enables App developers to package and deploy hybrid Apps on different target devices and platforms. Packaging and deployment of hybrid Apps can be made simply, efficiently and effectively by invoking the packager 110 via a single user initiated event associated with a UI element in the App builder. The packager 110 automatically resolves issues associated with the App dependencies, prepares all the required libraries, files and other resources, minifies App code, compresses and deploys the App package to multiple target devices and platforms.

As described, the packager 110 may be embodied as an application. For example, the packager 110 may be embodied as a software application. The application may be integrated into an existing software application, such as an App builder application, as an add-on or plug-in to an existing application, or as a separate stand-alone application. The existing software application may be a suite of software applications. The source code of the display system may be compiled to create an executable code. The codes, for example, may be stored in a storage medium, such as one or more storage disks. Other types of storage media may also be useful.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method of packaging and deploying a hybrid application, comprising:
in response to a single user selection event initiated via a user interface, receiving code of a hybrid application and a configuration file containing properties of the hybrid application;
identifying one or more initial dependencies from the configuration file;
resolving any one or more issues associated with the one or more initial dependencies to generate one or more final dependencies;
minifying the code of the hybrid application to generate minified code;
generating a package based on the one or more final dependencies and the minified code; and
compressing the package and deploying the compressed package to a target device or device simulator.

2. A computer-implemented method of packaging and deploying a hybrid application, comprising:
(i) receiving code of a hybrid application and a configuration file containing properties of the hybrid application;
(ii) identifying one or more initial dependencies from the configuration file;
(iii) resolving any one or more issues associated with the one or more initial dependencies to generate one or more final dependencies;
(iv) generating a package based on the one or more final dependencies and the code of the hybrid application; and
(v) deploying the package to a target device or device simulator.

3. The method of claim 2 wherein steps (i) to (v) are performed in response to a single user selection event.

4. The method of claim 2 further comprises generating the configuration file via a visual editor.

5. The method of claim 2 further comprises minifying the code of the hybrid application and generating the package based on the minified code.

6. The method of claim 5 wherein minifying the code comprises removing any whitespace, line break, comment or unnecessary statement in the code, optimizing any long variable name, function name or statement of the code, or a combination thereof.

7. The method of claim 2 further comprises compressing the package and deploying the compressed package to the target device or device simulator.

8. The method of claim 2 wherein resolving the issues associated with the one or more initial dependencies to generate the one or more final dependencies comprises:
checking the one or more initial dependencies to identify any one or more issues;
resolving the one or more identified issues; and
generating the one or more final dependencies that are free of issues.

9. The method of claim 8 wherein the issues include a conflict in the initial dependencies.

10. The method of claim 8 wherein checking the one or more initial dependencies to identify any one or more issues comprises checking the one or more initial dependencies to determine if a version of a resource associated with the initial dependencies is a latest version.

11. The method of claim 10 wherein if the version of the resource associated with the initial dependencies is not the latest version, automatically upgrading the version of the resource to the latest version.

12. The method of claim 8 wherein resolving the one or more identified issues comprises removing unrelated libraries.

13. The method of claim 8 wherein resolving the one or more identified issues comprises merging component libraries.

14. The method of claim 2 wherein generating the package comprises:
retrieving one or more resources associated with the one or more final dependencies;
combining the one or more resources into a combined resource package;
combining the code of the hybrid application into a code file;
minifying the code file; and
combining the combined resource package and minified code file into the package.

15. The method of claim 14 further comprises compressing the package using a compression algorithm.

16. The method of claim 2 further comprises generating a script using a platform software development kit (SDK) to deploy the package to a target platform.

17. The method of claim 16 wherein the target platform comprises Mac OS X, iOS, Android, Unix, Linux, Blackberry or Windows.

18. A non-transitory computer-readable medium having stored thereon program code, the program code executable by a computer to:
(i) receive code of a hybrid application and a configuration file containing properties of the hybrid application;
(ii) identify one or more initial dependencies from the configuration file;
(iii) resolve any one or more issues associated with the one or more initial dependencies to generate one or more final dependencies;
(iv) generate a package based on the one or more final dependencies and the code of the hybrid application; and
(v) deploy the package to a target device or device simulator.

19. A system comprising:
a non-transitory memory device for storing computer readable program code; and
a processor in communication with the memory device, the processor being operative with the computer readable program code to
(i) receive code of a hybrid application and a configuration file containing properties of the hybrid application;
(ii) identify one or more initial dependencies from the configuration file;
(iii) resolve any one or more issues associated with the one or more initial dependencies to generate one or more final dependencies;
(iv) generate a package based on the one or more final dependencies and the code of the hybrid application; and
(v) deploy the package to a target device or device simulator.

20. The system of claim 19 wherein the target device comprises a mobile device, an on-premise computer, a cloud computing system or a customer package site location.
